(19) United States
(12) Patent Application Publication
(10) Pub. No.: US 2020/0280579 A1
(43) Pub. Date: Sep. 3, 2020

(54) SYSTEM AND METHOD FOR ANALYZING INTERNET TRAFFIC TO DETECT DISTRIBUTED DENIAL OF SERVICE (DDOS) ATTACK

(71) Applicant: University of Manitoba, Winnipeg (CA)

(72) Inventors: Jesus David Terrazas Gonzalez, Winnipeg (CA); Witold Kinsner, Winnipeg (CA)

(21) Appl. No.: 16/646,815

(22) PCT Filed: Sep. 13, 2018
(86) PCT No.: PCT/CA2018/051132

§ 371 Date: Mar. 12, 2020

Related U.S. Application Data
(60) Provisional application No. 62/558,572, filed on Sep. 14, 2017.

(51) Int. Cl. H04L 29/06; G06N 3/08; G06N 3/04

(52) U.S. Cl. CPC H04L 63/1458; H04L 63/1425; H04L 2463/141; G06N 3/0409; G06N 3/08

(57) ABSTRACT

A system for analyzing internet traffic passing through an exposed computer device includes a preprocessing module for filtering the traffic so as to substantially isolate from the traffic features carrying data representative of a cyberattack, a perception module for extracting the data from the isolated features, a detection module for processing the extracted data to detect characteristics indicative of the cyberattack, and a mitigation module for generating responsive action if a cyberattack is detected.

### FIELD OF THE INVENTION

The present application relates to cybersecurity, and more specifically to detecting distributed denial of service (DDOS) attacks.

### BACKGROUND

Attempts have been made to detect distributed denial of service (DDOS) attacks in cyberspace. Some computer systems could be exposed to long periods of attack (e.g., days, weeks, or even months) without realising so. The harm caused by lengthy attacks translate often in huge economical loses for the target computer systems. Even an attack lasting minutes in a critical event that is supported by computer systems that are not expected to fail could cause financial losses.

DDOS cyberattacks are particularly dangerous because they are designed so as to make tracing their origin difficult. They are characteristic of increased traffic from a plurality of devices forming a botnet which may be controlled by a master orchestrating the attack. Typically, the master is able to gain control of the devices forming the botnet by infecting them with a virus. The increased traffic overwhelms a device being targeted so that it crashes.

### SUMMARY OF THE INVENTION

According to an aspect of the invention there is provided a system for analyzing traffic passing through an exposed computer device comprising:

a controller module for controlling operation of the system;

an input for receiving the traffic and an output for sending data to the exposed computer device;

a preprocessing module configured to filter the preprocessed traffic so as to substantially isolate from the traffic features carrying data representative of a cyberattack;

a perception module configured to extract the data from the features;

a detection module configured to process the extracted data using a machine learning algorithm arranged to detect characteristics indicative of the cyberattack and to produce a prescribed output signal when the cyberattack has been detected;

and a mitigation module configured to generate a responsive action to the cyberattack in response to the prescribed output signal of the detection module.

In this manner cyberattacks may be detected in real-time by use of digital signal processing techniques using low computing power.

Typically, there is provided a conditioning module intermediate the preprocessing module and the perception module such that the isolated features pass through the conditioning module so as to be conditioned prior to being received by the perception module.

“Traffic” refers to flow of (data) packets received by a computer device. The origin of the packets may be within a common private network or from a device outside the network such that the packets are transferred over the Internet.

“Exposed computing device/system” means the device/system is visible to other devices/systems (for example, inside a common private network, it can communicate with devices/systems on different networks via the Internet).

The system is implemented in at least one of hardware and software.

Typically the system further includes a storage module configured to store the extracted features in a manner available for later use. For example, this later use may take place outside of the system. Preferably the storage module is intermediate the perception module and the detection module.

Preferably the controller module is configured for bidirectional communication with each other module.

Preferably the preprocessing module and the conditioning module are configured for bidirectional communication with one another.

Preferably the conditioning module and the perception module are configured for bidirectional communication with one another.

Preferably the perception module and the storage module are configured for bidirectional communication with one another.

Preferably the storage module and the detection module are configured for bidirectional communication with one another.

Preferably the detection module and the mitigation module are configured for bidirectional communication with one another.

Preferably the preprocessing module is configured to communicate with the mitigation module. This is provided so that the preprocessing module can directly request action from the mitigation module so that the exposed computer device gets more immediate protection. Bidirectional communication among the preprocessing and mitigation modules may be facilitated by the controller module.

Preferably the preprocessing module is configured for bidirectional communication with the exposed computer device.

Preferably the mitigation module is configured for bidirectional communication with the exposed device.

In one arrangement, each of the controller module, the preprocessing module, the perception module, the conditioning module, the detection module, and the mitigation module is located in a common computing environment. That is, the system is located in a single computing environment. Thus, in such an arrangement the system works as an entity inside a networking environment with its components located in the same place.

In one arrangement, one of the controller module, the preprocessing module, the perception module, the conditioning module, the detection module, and the mitigation module and another one thereof are located in different computing environments. Thus, the system is formed by a distinct/hybrid computing environment. In such an arrangement, the system works as an entity even if its constituent modules are not physically located in the same place.

In one arrangement including the storage module, the storage module is located at in a common computing environment with the controller module, the preprocessing module, the perception module, the conditioning module, the detection module, and the mitigation module.

In another arrangement including the storage module, the storage module (is located in a distinct/hybrid computing environment from at least one of the controller module, the preprocessing module, the perception module, the conditioning module, the detection module, and the mitigation module.

In one arrangement, each of the controller module, the preprocessing module, the perception module, the conditioning module, the detection module, and the mitigation module is located at a common geographical location. This means that the system works as an entity inside a single geographical location with its physical components located in the same geographical area (for example, an agency/country that would not want data flowing out of its borders).

In one arrangement, one of the controller module, the preprocessing module, the perception module, the conditioning module, the detection module, and the mitigation module and another one thereof are located at distinct geo-locations. This means that the system works as an entity even if some of its parts are situated in distinct geographical locations (that is, data can flow beyond an agency's or country's borders).

In one arrangement including the storage module, the storage module is located at a common geographical location with the controller module, the preprocessing module, the perception module, the conditioning module, the detection module, and the mitigation module.

In another arrangement including the storage module, the storage module is located at a distinct geo-location from at least one of the controller module, the preprocessing module, the perception module, the conditioning module, the detection module, and the mitigation module.

In one arrangement, each of the controller module, the preprocessing module, the perception module, the conditioning module, the feature detection module, and the cyberdefense and intrusion mitigation module is located in a common logical networking environment. That is, all of the modules are located in a single logical networking environment. This means that the system would work as an entity inside a geographical location that would require its physical components to be located in the same geographical area (e.g., an agency/country that would not want data flowing out of its borders).

In one arrangement, one of the controller module, the preprocessing module, the perception module, the conditioning module, the detection module, and the mitigation module and another one thereof are located in different networking environments. That is, the system is formed by a virtual or hybrid networking environment. Virtual/hybrid networking environment means that some modules of the system may be sandboxed, for example in order to secure malware.

In one arrangement including the storage module, the storage module is located at in a common logical networking environment with the controller module, the preprocessing module, the perception module, the conditioning module, the detection module, and the mitigation module.

In another arrangement including the storage module, the storage module is located in a different logical networking environment from at least one of the controller module, the preprocessing module, the perception module, the conditioning module, the detection module, and the mitigation module.

In one arrangement, one of the controller module, the preprocessing module, the perception module, the conditioning module, the detection module, and the mitigation module and another one thereof are communicable using tokens carrying information or instructions.

There may be formed a feedback loop between one of the controller module, the preprocessing module, the perception module, the conditioning module, the feature detection module, and the mitigation module and another one thereof.

Preferably the preprocessing module defines the input of the system.

Preferably the mitigation module defines the output of the system.

In one arrangement the extraction and machine learning module is configured to apply zero-crossing rate to the isolated features to form the extracted data.

In one arrangement the machine learning algorithm of the detection module comprises Hebbian learning.

In another arrangement the machine learning algorithm of the detection module comprises adaptive resonance theory.

According to another aspect of the invention there is provided a system for analyzing traffic passing through a computing device/system exposed to the Network/Internet.

### BRIEF DESCRIPTION OF THE DRAWINGS

An arrangement of the invention will now be described in conjunction with the accompanying drawings in which:

FIG. 1 is a schematic diagram showing exchange of data between a set of foreign computer devices and another computer device which is exposed and that may form a target of a cyberattack.

FIG. 2 is a schematic diagram of system according to an arrangement of the present invention.

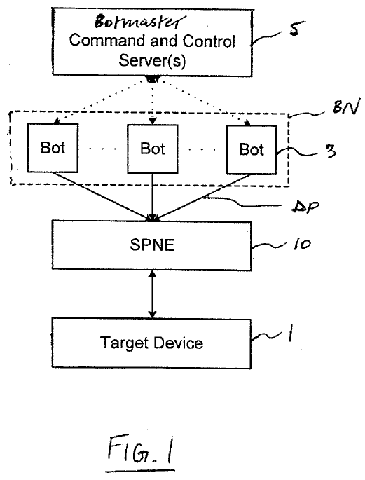

Further is provided a legend to identify tokens illustrated in FIG. 1:
[symbol] Data Token
[symbol] Control Token
\textcircled{1} Control Addendum (CA)
[symbol] Classified Data (CD)
[symbol] Countermeasure Response (CR)
\textcircled{2} Countermeasure Response Feedback (CRF)
[symbol] Data Addendum (DA)
\textcircled{3} Data Availability Feedback (DAF)
\textcircled{4} Data Availability Location (DAL)
\textcircled{5} Data Reception Acknowledgement (DRA)
\textcircled{6} Feedback Addendum (FA)
[symbol] Features Extracted from Data (FED)
[symbol] Internet/Network Traffic (INT)
\textcircled{7} Internet/Network Traffic Feedback (INTF)
\textcircled{8} Internet/Network Traffic Sniffing (INTS)
\textcircled{9} Integration Time Window (ITW)
\textcircled{A} Integration Window Feedback (IWF)
\textcircled{B} Machine Learning Algorithm (MLA)
[symbol] Machine Learning Feedback (MLF)
[symbol] Packets Section(s) (PS)
\textcircled{C} Packets Section(s) Reception Acknowledgement (PSRA)
\textcircled{D} Trigger Cyberdefense Countermeasures (TCDC)
[symbol] Trigger Cyberdefence Countermeasures Feedback (TCF)
\textcircled{E} Time Series (TS)
\textcircled{F} Traffic Sniffing Feedback (TSF)
\textcircled{G} Time Series Reception Acknowledgement (TSRA)
\textcircled{H} Window Size Feedback (WSF)
\textcircled{I} Window Size Overlap (WSO)

In the drawings like characters of reference indicate corresponding parts in the different figures.

### DETAILED DESCRIPTION

There is illustrated in the figures a system 10 for analyzing Internet/network traffic passing through an exposed computer device 1 which is able to receive the traffic in the form of data packets from another computer device 3, whether on the same network as the device 1 or on a different network such that the traffic is communicated to the device 1 via the Internet. The system 10 is referred to hereinafter as a “secure processing and networking engine” (SPNE) for convenience of reference.

The SPNE 10 is particularly suited for analyzing the traffic so as to detect a distributed denial of service (DDOS) attack.

To carry out a DDOS attack, a master device 5 forms a botnet BN comprising a plurality of devices like those indicated at 3 in FIG. 1 which typically are unaware they've been infected and that the master 5 controls and uses to carry out the attack on the target device 1. When receiving a connection request form another device 3, the exposed device 1 must respond to this request. In the DDOS style of attack, the incoming traffic to the exposed device 1 increases to the point that the target device 1 is overwhelmed and can no longer accept connections or reply.

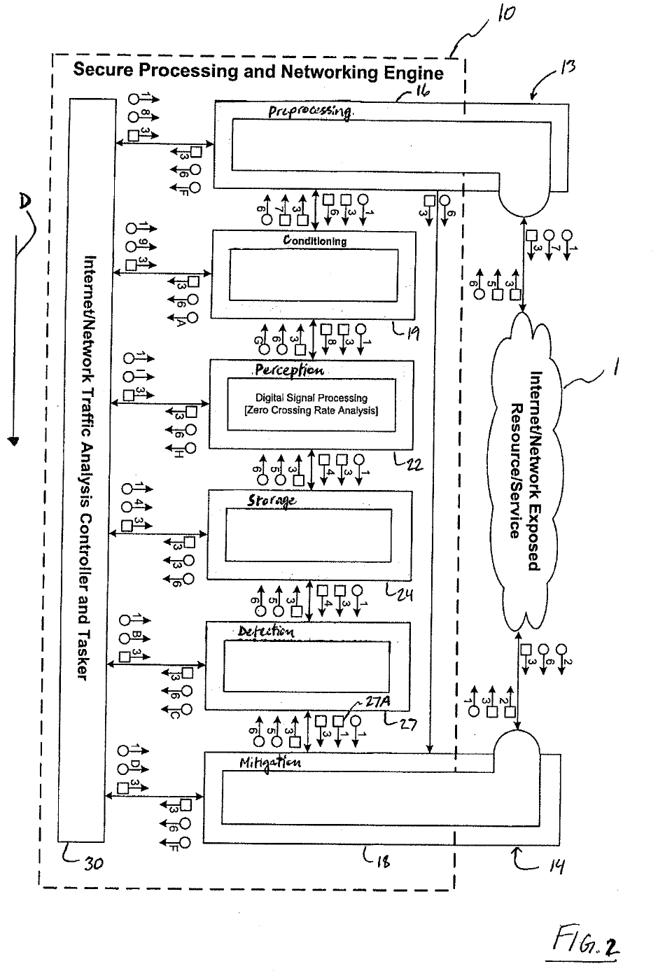

As such, FIG. 1 illustrates a plurality of ‘foreign’ computer devices 3 each sending data packets, respectively indicated by arrows DP, and collectively forming the incoming traffic to the exposed computer device 1. The SPNE 10 may in some arrangements act as a shield to the exposed computer device, which forms a target of the cyberattack, analyzing the raw traffic before it hits the device 1. The SPNE 10 comprises a plurality of modules each of which performs a dedicated function within the engine 10, and thus the SPNE has a modular architecture, as illustrated by that which is enclosed by the dashed line in FIG. 2, an input 13, and an output 14. The input 13 and output 14 connect to a resource/service 1 that is exposed to the Internet/network. In the illustrated arrangement the input 13 to the SPNE is defined by a preprocessing module 16, which may also be referred to as a traffic sensing module. The output 14 of the illustrated arrangement is defined by a cyberdefense and intrusion mitigation module 18. Only these two modules 16, 18 are in contact with the digital world outside the SPNE. This allows the SPNE 10 to be secured so that no other modules of the engine 10 are reachable by outsiders such as human agents with unknown/obscure intentions or software bots attempting to pierce the SPNE so that its operations are compromised.

The preprocessing module 16 which defines the input 13 of the system for sniffing or receiving the traffic for subsequent analysis by the system is configured to digitally preprocess the traffic in a manner readying it for further processing in the system, so that it can be determined whether the exposed computer device 1 to which the system 10 is connected is under cyberattack. Thus, the preprocessing module senses the Internet/network traffic processed by the system 10.

The preprocessing module captures the traffic in the form of standardized data packets which are transmitted and received by computer devices.

Since the analysis of the traffic occurring in the system 10 can be highly complex, the traffic is preprocessed by the preprocessing module, thereby preparing it for subsequent analysis in the system, by selecting a subset of its properties of interest (e.g., number of packets or size of the packets) so as to fragment the traffic. Typically, information about the traffic includes timestamps which does not make it suitable for filtering, and thus in the illustrated arrangement the timestamps are removed by the preprocessing module. As such, the preprocessing comprises filtering this traffic so as to isolate from amongst all data associated with the traffic packets those features which are representative of a cyberattack and from which features will be extracted and analyzed. That is, the isolated features carry data from which it can be determined whether a cyberattack has occurred or is underway. In this manner, only the relevant data remains for transmitting to downstream modules so that these are not overwhelmed by large amounts of data, some of which is not useful for ascertaining the cyberattack.

The preprocessing module breaks down the sensed traffic into segments (e.g., transmission of a packets, information of the packet size, information of the interarrival time between packets) that carry significant information about the cyberattack so that in can be perceived and detected successfully by the machine learning.

The preprocessing module may capture the incoming traffic to the exposed device 1 but may also capture outgoing traffic being transmitted by the device 1 so that the system is enabled to monitor the device 1 to determine if it has been subject of a traffic anomaly and consequentially a potential cyberattack.

A conditioning module 19 receives the traffic once preprocessed by the Internet/network preprocessing module 16 and conditions, cleans, or aggregates the isolated features so that they are readied for data extraction at a perception module 22, which may also be referred to as an extraction module. The term ‘aggregate’ as used here refers to collecting related items of content so as to display or link to them. In the arrangement described in detail herein, this cleaning includes removal of the timestamps on the isolated features.

Thus, the conditioned features pass to the perception module 22 which is configured to further process the preprocessed traffic by applying generalized data transformations (e.g., zero-crossing rate or an alternative digital signal processing methods or techniques that would be suitable) thereto, in order to extract relevant data from the isolated features.

The perception module 22 is configured to transform the isolated traffic properties by digital signal processing techniques, generalized data transformations, for extracting relevant and robust features. For example, the traffic properties of interest include size of the packets, number of packets, and whether or not the packets are encrypted. In the arrangement described in detail in this disclosure, the signal processing technique applied at module 22 is zero-crossing rate (ZCR) which determines how many times a signal has crossed a reference level, such as zero or a DC offset, within a specified interval. In other words, ZCR is a measure of “frequency composition” of a signal, which is more valid for narrowband signals such as sinusoids. This provides an indication of how “busy” a signal becomes which can be estimated by the number of times it crosses either the zero-activity line for alternating signals, or some other reference level for oscillating signals. ZCR is fast but uses as its input a conditioned or cleaned signal. In the arrangement described in detail herein, ZCR is realized according to the pseudocode form below:

Zero-Crossing Rate

| | |
|---|---|
| 1: | Define size of signal to analyze: x |
| 2: | Define size of procesing window: w |
| 3: | Calculate how many succesive times zₙ, w can be acomodated inside |
| | the signal x. Either a non-overlapping or overlaping criteria can be |
| | applied. |
| 4: | for n = 1 to zₙ, do |

| | |
|---|---|
| 5: | z(n) = Σ^{∞}_{m=-∞}\|sgn(x[n])−sgn(x[m−1])w[n−m]\| |

| | |
|---|---|
| 6: | end for |

Downstream of the perception module is a storage module 24 configured to store the extracted data in a manner available for use outside of the system 10. The data may be stored temporarily for example by means of buffering or permanently for example by dedicated digital storage. Only the extracted data is stored as this is the data which is indicative of a cyberattack, and it may be used for research purposes for example to determine if there are alternative algorithms for analyzing the data to ascertain a cyberattack. The stored data may also be classified by an entity outside the system 10. Additionally, the storage module may be configured to classify the data and act as a pre-screening module for subsequently triggering operation or initiating a downstream detection module 27 to analyze the data using a suitable machine learning algorithm, which is described in further detail below.

“Downstream” refers to direction of the flow of information D within the system from the input 13 to the output 14 along which the system first receives raw traffic, prepares it for analysis, analyzes it, and lastly responds in some form based on the determination by the analysis if there is a cyberattack.

A detection module 27 configured to process the extracted data to determine if there is a cyberattack is downstream of the storage module (processed/analyzed data availability) and receives as its input the same extracted data received by the storage module (processed/analyzed data availability). As such, the storage (processed/analyzed data availability) module 24 is located intermediate the perception module 22 and the detection module 27.

The detection module uses a suitable machine learning algorithm which analyzes the extracted features from the traffic properties for patterns and is thus arranged to detect characteristics indicative of the cyberattack. In the arrangement described in detail this disclosure, either Hebbian learning and Adaptive Resonance Theory (ART) is used for cyberattack detection purposes.

Each one of Hebbian learning and ART are a type of deep machine learning algorithm which recognizes patterns and which are self-learning and unsupervised, that is they do not require supervised training with a labeled training dataset. Although it may be possible to implement a trained neural network as the machine learning algorithm of the detection module 27, this may be less effective for real-time applications and not as robust as a self-learning, unsupervised algorithm.

In the arrangement described in detail herein, the least mean square (LMS) algorithm of Widrow and Hoff is implemented in modified form to perform unsupervised learning for the machine learning algorithm of the detection module and, as such, LMS can be used to implement Hebbian learning.

Adaptive resonance theory (ART) uses a neural network architecture, which grows or shrinks as needed (that is, it adapts), for the learning of recognition categories. This architecture self-organizes and self-stabilizes its recognition codes with a single parameter that tunes a response to arbitrary orderings of, possibly complex, binary input patterns, which could create arbitrarily as many classification categories as needed.

ART categories 1 and 2 are sufficient for the purposes of the system 10 because the signals being analyzed, that is the extracted data, are binary by nature.

Some of the appealing features of the neural network architecture supported by ART are: there is only one parameter to be determined, clusters of the same size are built, and incremental learning (native in biological systems) is inherently simulated.

The Applicant believes this to be the first disclosure in which algorithms of these types are used in a cybersecurity application. In a cybersecurity application, it is preferred that a detection algorithm is capable of incremental learning on its own.

As such, using the machine learning algorithm the extracted data is analyzed and classified as typical/normal or as anomalous based on a comparison to the historical data of previously analyzed traffic classified as typical or normal.

Once the extracted data have been analyzed in the detection module, a prescribed output token 27A is provided. This token 27A contains the classification information about whether the traffic is healthy or if a cyberattack has been detected. Upon detection of a cyberattack, based thereon a prescribed output signal 27A produced by the detection module to the cyberdefense and intrusion mitigation module 18.

Downstream of the detection module 27 is the cyberdefense and intrusion mitigation module 18 which is configured to generate a responsive action to the cyberattack in response to the prescribed output signal 27A of the detection module.

That is, once an indication of the presence of a cyberanomaly is provided by the pattern recognition/machine learning module, a cyberdefence action is expected. These responsive actions are highly complex as they are expected to be executed fast. Some computer systems are under long periods of attack (e.g., days, weeks, or even months) without realising so, and the harm caused by lengthy attacks often translate into huge economical loses for the target computer systems. Even an attack lasting minutes in a critical event that is supported by computer systems that are not expected to fail could cause financial losses.

Responsive actions taken by the mitigation module include (i) configuring the exposed computer device 1 to be unreachable to attackers or abusing systems for example those indicated at 3 by shutting down or disconnecting from the network, (ii) enhancement vulnerability for capturing high quality data of attacks so that better cybersecurity and cyberdefense systems can be made, and (iii) activation of sandboxes, that is isolated computing systems contained in virtual computing environments, for system penetration avoidance and triggering data collection of anomalous events detected. Thus, in some arrangements, a cybersecurity countermeasure is taken by the mitigation module 18. In other arrangements, the responsive action may be a decision made within module 30.

The system also includes a controller module 30 module for controlling operation of the system. It is the executive entity within the SPNE because it instructs and supervises the rest of the modules present in the SPNE. The controller module may be referred to hereinafter as the “Internet/network traffic analysis controller and tasker” (INTACT) for convenience of reference.

This controller is air gapped with respect to the resource/service 1 exposed to the Internet/network, that is the controller is isolated from the outside networking environment, by at least one degree. Air gapping diminishes the possibilities of a computing system being compromised. Hence, by air gapping the controller module, the possibilities of it being compromised are reduced.

The controller module 30 is configured for bidirectional communication with each other module of the engine 10. Furthermore, each pair of modules which is adjacent one another relative to the downstream direction D are configured for bidirectional communication with one another. Bidirectional communication provides efficient movement of data and control tokens, which participate in the creation of local and global feedback loops.

Furthermore, the preprocessing module is configured to communicate with the mitigation module. This direct communication allows for quicker action to be taken by the cyberdefense and intrusion mitigation 18 in the event that information about a cyberattack is available. Even though direct unidirectional communication is shown in FIG. 2, bidirectional communication is possible via INTACT. The flow of information among the subsystems in the SPNE takes place using tokens, which font's the communication protocol inside the system 10. Tokens are packets carrying data or instructions to perform a given operation (known as data squares and control circles, or tokens, respectively) in the computing systems responsible for implementing the SPNE 10. Generally speaking, data tokens transmit information about information, and control tokens carry instructions/commands for recipient modules.

The flow of information using tokens allows for the efficient exchange of information when specific events take place (for example, a threshold reached, a given amount of traffic captured, processing a window of raw data, running a digital signal processing algorithm, data buffering, permanently store data, detection of a pattern in a machine learning algorithm, launching a defense mechanism, to name a few) particularly when the SPNE is distributed amongst several distinct locations in software/hardware. That is, the use of tokens as a communication protocol for the system affords greater modularity to the system 10. Communication by use of tokens is a substitute for communication between system modules by physical interconnection with wires or by wireless protocol so that each module is more readily replaceable upon a failure or attack thereon. The token communication protocol may also be less susceptible to interference by outside attackers.

Furthermore, there are specialized data addendum and control addendum tokens that allow the amalgamation of additional information which may be suited for certain arrangements of the system 10.

Specifically, the modules communicate using the following tokens:

The INTACT 30 and the preprocessing module 16 are configured for bidirectional communication with one another involving sending from the controller to the preprocessing module data token 3 containing data addendum information and control tokens 1 and 8 respectively containing control addendum information and information regarding triggering cyberdefence countermeasure feedback, and sending from the preprocessing module to the controller module data token 3 containing data addendum information and control tokens 6 and F respectively containing feedback addendum information and feedback from the preprocessing module.

The INTACT and the conditioning module 19 are configured for bidirectional communication with one another involving sending from the controller module to the conditioning module data token 3 containing data addendum information and control tokens 1 and 9 respectively containing control addendum information and instructions for the conditioning module (e.g., including integration time window information), and sending from the conditioning module to the controller module data token 3 (data addendum information) and control tokens 6 and A respectively containing feedback addendum information and feedback information from the conditioning module (e.g., including integration window feedback information).

The INTACT and the perception module 22 are configured for bidirectional communication with one another involving sending from the controller module to the perception module data token 3 (data addendum information) and control tokens 1 and I respectively containing control addendum information and instructions for the perception module (e.g., window size overlap), and sending from the perception module to the controller module data token 3 and control tokens 6 and H respectively containing feedback addendum information and feedback from the perception module (e.g., window size feedback).

The INTACT and the storage module 24 are configured for bidirectional communication with one another involving sending from the controller module to the storage module data token 3 (data addendum information) and control tokens 1 and 4 respectively containing control addendum information and feedback from the storage module (e.g., location where stored data is available), and sending from the storage module to the controller module data token 3 (data addendum information) and control tokens 3 and 6 respectively containing feedback information from the storage module and feedback addendum information.

The INTACT and the detection module 27 are configured for bidirectional communication with one another involving sending from the controller module to the detection module data token 3 (data addendum information) and control tokens 1 and B respectively containing control addendum information and instructions to the detection module (e.g., the machine learning algorithm to be implemented), and sending from the detection module to the controller module data token 3 (data addendum information) and control tokens 6 and C respectively containing feedback addendum information and feedback from the detection module (e.g., acknowledgement information that the data from isolated features has been received at the detection module).

The INTACT and the mitigation module 18 are configured for bidirectional communication with one another involving sending from the controller module to the mitigation module data token 3 (data addendum information) and control tokens 1 and D respectively containing control addendum information and instructions for the mitigation module (e.g., to trigger cyberdefence countermeasure), and sending from the mitigation module to the controller module data token 3 (data addendum information) and control tokens 6 and F respectively containing feedback addendum information and feedback information from the mitigation module (e.g., traffic sniffing feedback).

The preprocessing module 16 is configured for bidirectional communication with the exposed resource/service 1 involving sending from the preprocessing module to the exposed device data token 3 (data addendum information) and control tokens 1 and 7 respective containing control addendum information and feedback information from the preprocessing module, and receiving from the device 1 data token 3 (data addendum information) and control tokens 5 and 6 respectively containing feedback information from the device 1 (e.g., data reception acknowledgement) and feedback addendum information.

The preprocessing module and the conditioning module 19 are configured for bidirectional communication with one another involving sending from the preprocessing module to the conditioning module data tokens 3 and 6 respectively containing data addendum information and feedback about the detection module (e.g., machine learning feedback) and control token 1 (control addendum information), and sending from the conditioning module to the preprocessing module data tokens 3 and 7 respectively containing data addendum information and feedback information from the conditioning module (e.g., packet sections) and control token 6 (feedback addendum information).

The preprocessing module is configured for communication with the mitigation module 18 involving sending thereto data token 3 (data addendum information) and control token 6 (feedback addendum information).

The conditioning module 19 and the perception module 22 are configured for bidirectional communication with one another involving sending from the conditioning module to the perception module data tokens 3 and 8 respectively containing data addendum information and feedback about the mitigation module (e.g., trigger cyberdefense countermeasure feedback) and control token 1 (control addendum information), and sending from the perception module to the conditioning module data token 3 (data addendum information) and control tokens 6 and G respectively containing feedback addendum information and feedback from the perception module (e.g., time series reception acknowledgement).

The perception module 22 and the storage module 24 are configured for bidirectional communication with one another involving sending from the perception module to the storage module data tokens 3 and 4 respectively containing data addendum information and feedback about the information being extracted at the perception module and control token 1 (control addendum information), and sending from the storage module to the perception module data token 3 (data addendum information) and control tokens 5 and 6 respectively containing feedback information from the storage module (e.g., data reception acknowledgement) and feedback addendum information.

The storage module 24 and the detection module 27 are configured for bidirectional communication with one another involving sending from the storage module to the detection module data tokens 3 and 4 respectively containing data addendum information and feedback about the information extracted at the perception module and control token 1 (control addendum information), and sending from the detection module to the storage module data token 3 (data addendum information) and control tokens 5 and 6 respectively containing feedback information from the detection module (e.g., data reception acknowledgement) and feedback addendum information.

The detection module 27 and the mitigation module 18 are configured for bidirectional communication with one another involving sending from the detection module to the mitigation module data tokens 1 and 3 respectively containing classified data and data addendum information and control token 1 (control addendum information), and sending from the mitigation module to the detection module data token 3 (data addendum information) and control tokens 5 and 6 respectively containing feedback information from the mitigation module (e.g., data reception acknowledgement) and feedback addendum information.

The mitigation module 18 is configured for bidirectional communication with the exposed resource/service 1 involving sending thereto data tokens 2 and 3 respectively containing the responsive action generated by the mitigation module (e.g., countermeasure response) and data addendum information and control token 1 (control addendum information), and receiving from the device 1, the data token 3 (data addendum information) and the control tokens 2 and 6 respectively containing feedback from the device (e.g., countermeasure response feedback) and feedback addendum information.

The bidirectional communication between modules forms a plurality of feedback loops allowing for adjustments to be made to operation of the system. More specifically, a plurality of local feedback loops are formed inside the system 10 between each pair of system modules configured for bidirectional communication, and global feedback loops are formed between the system 10 and the exposed computer device 1—one at the input 13 and another at the output 14 of the system.

The controller module 30 supervises and oversees sustainability of the local and global feedback loops. The feedback loops strengthen the dataflow in the inner computing processes and tasks taking place in the additional modules.

The modules of the system may be implemented in hardware or in software, and a single system may include some components implemented in hardware and others implemented in software so as to form a hybrid implementation. The more modules implemented in hardware, the greater the speed of the system which allows for faster detection and response to a cyberattack. Furthermore, hardware implementations of configurable devices may be more difficult to modify by an external device attacking the system 10.

For example, at least one module of the system may be implemented in hardware in a field programmable gate array (FPGA) which is a hardware reconfigurable device.

In an arrangement of the system which includes at least some components implemented in software, there is provided a computing device comprising at least one processor for controlling operation of the computing device; and a memory (or a non-transitory computer storage medium) storing data and program instructions used by the at least one processor, wherein the at least one processor is configured to execute instructions stored in the memory to form an instance of each one of the system modules to be provided in software and to carry out the function of the respective module within the system.

The system 10 is therefore distributed as it is formed by a plurality of distinct modules each performing a dedicated task, so that if one of the modules fails or is attacked this module may be replaced and the system can continue to operate.

All modules may be located in a single computing environment, or in other words in a single computing system. In a single computer environment, the creation of local and global feedback loops found in cognitive systems is possible. Alternatively, at least one of the modules may be located in a different computer environment such that the engine 10 is formed by a distinct/hybrid computing environment in which that the cooperating components of the engine are located in separate computer systems.

All modules may be located in a common, i.e. the same, geographical such that flow of analyzed traffic remains contained within a given geographical area, for example the flow remains within the geographical country borders where an agency implementing the system 10 is located. In case of a hardware implementation of the engine 10, if the modules are to stay within a given location the engine 10 can accommodate that. Alternatively, at least one of the modules may be located in a distinct geo-location, for example if there is no restrictions for on where the traffic under analysis may flow.

All modules may be integrated in a single logical networking environment. Alternatively, at least one of the modules is integrated in a different logical networking environment such that the engine 10 is formed by a virtual or hybrid networking environment. There may be different networks that have overlap in access to hardware or software. In a virtual or hybrid networking environment, these resources are accessible logically, but a foreign network cannot access the networking system that owns such resources. Thus, components of the system 10 can be placed in virtual environments in order to sandbox a cyberattack or just to provide extra protective shields.

Thus, the system 10 analyzes traffic and may detect a cyberattack by performing the following steps:

1) Receive the traffic flowing into the exposed computer device in real-time;

2) Preprocess the traffic so as to isolate those features carrying data representative of a cyberattack;

3) Condition the isolated featured enabling better extraction of data therefrom;

4) Extract the data from the conditioned features;

5) Optionally store the extracted data for future use, such as for research;

6) Analyze the extracted data by applying a machine learning algorithm to detect an anomaly in the traffic;

7) Upon the indication of an anomaly, respond to the cyberattack.

The system 10 is able to analyze traffic for purposes of detecting a cyberattack, but also is secure so as to itself not be compromised by an attack thereon. The modular architecture of the system, at least part of which allows different components of the system to be located in different types of computing environments, geographical locations, and logical networking environments, and communication between modules using tokens affords robustness and flexibility to the system so that it may be adapted to changing conditions in the digital world outside the engine 10 such that the engine may continue to survive in same.

Since various modifications can be made in my invention as herein above described, and many apparently widely different embodiments of same made, it is intended that all matter contained in the accompanying specification shall be interpreted as illustrative only and not in a limiting sense.

1. A system for analyzing traffic passing through an exposed computer device comprising:
a controller module for controlling operation of the system;
an input for receiving the traffic and an output for sending data to the exposed computer device;
a preprocessing module configured to filter the preprocessed traffic so as to substantially isolate from the traffic features carrying data representative of a cyberattack;
a perception module configured to extract the data from the features;
a detection module configured to process the extracted data using a machine learning algorithm arranged to detect characteristics indicative of the cyberattack and to produce a prescribed output signal when the cyberattack has been detected;
and a mitigation module configured to generate a responsive action to the cyberattack in response to the prescribed output signal of the detection module.

2. The system according to claim 1 wherein the system is implemented in at least one of hardware and software.

3. The system according to claim 1 or 2 further including a conditioning module intermediate the preprocessing module and the perception module such that the isolated features pass through the conditioning module so as to be conditioned prior to being received by the perception module.

4. The system according to any one of claims 1 to 3 further including a storage module configured to store the extracted data in a manner available for use outside of the system.

5. The system according to claim 4 wherein the storage module is intermediate the perception module and the detection module.

6. The system according to any one of claims 1 to 5 wherein the controller module is configured for bidirectional communication with each other module.

7. The system according to claim 3 wherein the preprocessing module and the conditioning module are configured for bidirectional communication with one another.

8. The system according to claim 3 or 7 wherein the conditioning module and the perception module are configured for bidirectional communication with one another.

9. The system according to claim 4 or 5 wherein the perception module and the storage module are configured for bidirectional communication with one another.

10. The system according to any one of claims 4, 5 and 9 wherein the storage module and the detection module are configured for bidirectional communication with one another.

11. The system according to any one of claims 1 to 10 wherein the detection module and the mitigation module are configured for bidirectional communication with one another.

12. The system according to any one of claims 1 to 11 wherein the preprocessing module is configured to communicate with the mitigation module.

13. The system according to any one of claims 1 to 12 wherein the preprocessing module is configured for bidirectional communication with the exposed computer device.

14. The system according to any one of claims 1 to 13 wherein the mitigation module is configured for bidirectional communication with the exposed computer device.

15. The system according to any one of claims 1 to 14 wherein each of the controller module, the preprocessing module, the perception module, the detection module, and the mitigation module is located in a common computing environment.

16. The system according to any one of claims 1 to 15 wherein one of the controller module, the preprocessing module, the perception module, the detection module, and the mitigation module and another one thereof are located in different computing environments.

17. The system according to any one of claims 4, 5, 9 and 10 wherein the storage module is located in a common computing environment the controller module, the preprocessing module, the perception module, the detection module, and the mitigation module.

18. The system according to any one of claims 4, 5, 9 and 10 wherein the storage module is located in a distinct computing environment from at least one of the controller module, the preprocessing module, the perception module, the detection module, and the mitigation module.

19. The system according to any one of claims 1 to 18 wherein each of the controller module, the preprocessing module, the perception module, the detection module, and the mitigation module is located at a common geographical location.

20. The system according to any one of claims 1 to 19 wherein one of the controller module, the preprocessing module, the perception module, the detection module, and the mitigation module and another one thereof are located at distinct geo-locations.

21. The system according to any one of claims 4, 5, 9, 10, 17 and 18 wherein the storage module is located at a common geographical location with the controller module, the preprocessing module, the perception module, the detection module, and the mitigation module.

22. The system according to any one of claims 4, 5, 9, 10, 17 and 18 wherein the storage module is located at a distinct geo-location from at least one of the controller module, the preprocessing module, the perception module, the detection module, and the mitigation module.

23. The system according to any one of claims 1 to 22 wherein each of the controller module, the preprocessing module, the perception module, the detection module, and the mitigation module is located in a common logical networking environment.

24. The system according to any one of claims 1 to 23 wherein one of the controller module, the preprocessing module, the perception module, the detection module, and the mitigation module and another one thereof are located in different networking environments.

25. The system according to any one of claims 4, 5, 9, 10, 17, 18, 21 and 22 wherein the storage module is located at in a common logical networking environment with the controller module, the preprocessing module, the perception module, the detection module, and the mitigation module.

26. The system according to any one of claims 4, 5, 9, 10, 17, 18, 21 and 22 wherein the storage module is located in a different logical networking environment from at least one of the controller module, the preprocessing module, the perception module, the detection module, and the mitigation module.

27. The system according to any one of claims 1 to 26 wherein one of the controller module, the preprocessing module, the perception module, the detection module, and the mitigation module and another one thereof are communicable using tokens carrying information or instructions.

28. The system according to any one of claims 1 to 27 wherein there is formed a feedback loop between one of the controller module, the preprocessing module, the perception module, the detection module, and the mitigation module and another one thereof.

29. The system according to any one of claims 1 to 28 wherein the preprocessing module defines the input of the system.

30. The system according to any one of claims 1 to 29 wherein the mitigation module defines the output of the system.

31. The system according to any one of claims 1 to 30 wherein the perception module is configured to apply zero-crossing rate to the isolated features to form the extracted data.

32. The system according to any one of claims 1 to 32 wherein the machine learning algorithm of the detection module comprises Hebbian learning.

33. The system according to any one of claims 1 to 31 wherein the machine learning algorithm of the detection module comprises adaptive resonance theory.
